(19) United States
(12) Patent Application Publication
(10) Pub. No.: US 2014/0311064 A1
(43) Pub. Date: Oct. 23, 2014

(54) Rain Screen Framing System

(71) Applicant: MOTO Extrusions, Inc., Capitola, CA (US)

(72) Inventors: Brent Beaty, Soquel, CA (US); Daniel Gomez, Aptos, CA (US); Daniel Townsend, Aptos, CA (US)

(73) Assignee: MOTO EXTRUSIONS, INC., Capitola, CA (US)

(21) Appl. No.: 14/260,248

(22) Filed: Apr. 23, 2014

Related U.S. Application Data
(60) Provisional application No. 61/854,368, filed on Apr. 23, 2013.

(51) Int. Cl. E04B 2/58; E04B 2/02; E06B 1/36; E04B 2/16; E06B 1/34

(52) U.S. Cl. CPC E04B 2/58; E04B 2/16; E06B 1/34; E06B 1/36; E04B 2/02; E04B 2002/0256
USPC 52/204.53; 52/483.1

(57) ABSTRACT

The present invention provides a universal framing system for securing cladding to the interior or exterior of a structure. The framing system comprises hat channels, face plates, Z-channels, inside corner trims, outside corner trims, and window trims. The components of the framing system are secured to a wall of a structure, then panels of cladding are secured to the components.

This application claims the benefit of U.S. Provisional Application No. 61/854,368, filed Apr. 23, 2013.

### TECHNICAL FIELD

The present invention generally relates to a framing system for cladding the exterior or interior of a structure.

### BACKGROUND

Cladding the exterior and interior of residential and commercial buildings is gaining popularity. Exterior cladding may include a rain screen to protect the interior elements. Installation of cladding requires a framing system mounted to typically a wall of a structure, but may also be mounted to a roof, soffit, ceiling, floor, etc. The cladding is attached to the framing system. The framing system is typically made from galvanized metal. However, galvanized metal has many drawbacks.

One disadvantage is that galvanized metal cannot be used in coastal areas or areas of high moisture as the galvanized coating is insufficient to resist corrosion in these regions. Another disadvantage is that galvanized metal is difficult to cut and drill, which increases the cost and quality of the installation. Another disadvantage is that galvanized metal parts very rarely true, which requires additional labor to level components. Another disadvantage is that galvanized metal parts should be resealed after cutting or drilling to restitute the removed surface coating. Another disadvantage of conventional framing systems is that they normally provide a single-type of framing element, which must be cut and positioned to fit the geometric differences of the several structures and features (e.g., windows, doors, soffits, and corners) found on modern buildings. This one size fits all approach has proven inadequate and further increases the difficulty and cost of installation.

Another disadvantage of conventional cladding is that it fails to position the frames of the windows flush with the cladding. Windows are not normally perfectly aligned. When conventional cladding is applied, the misalignment of windows is magnified and more noticeable and thus aesthetically unpleasing. Often the window frame has a different offset than the cladding, which is also aesthetically unpleasing.

As such, there is a need for a framing system that has a greater resistance to corrosion, is simple and efficient to install, and adaptable to many different buildings and structural features. The system needs to be able to enhance the aesthetic appearance, especially of windows. Still further, there is a need for a framing system that has these advantages to capable of being manufactured cost effectively and from low cost materials.

### SUMMARY

The present invention provides a universal framing system for securing cladding to the interior or exterior of a structure. The present invention also provides cooperative window framing that improves alignment of installed windows with the cladding.

In an embodiment of the present invention, a sub-framing wall system for supporting cladding attached to a wall is provide, the sub-framing system comprising a hat channel having an elongated planar base, a pair of side walls extending upward from the base, and a latch extending inward from each side wall. A cap seat extends above each latch and outward of each side wall. First and second flanges extend outward from each cap seat. The hat channel is secured to a wall panel by fasteners extending through the base.

A face plate is provided having an elongated, planar body with an interior and opposite exterior surface. A pair of opposing side legs extends downward from the interior surface of the body. A strike ridge extends outward from each side leg. The strike ridges engage the latches of the hat channel to secure the face plate in compression against the cap seat of the hat channel. This provides a metal seal over the fasteners that penetrate the hat channel. A first panel of cladding is secured to the first flange. A second panel of cladding is secured to the second flange adjacent to the first panel such that the adjacent edges of the first and second panels are positioned over the face plate. This provides a solid backing to the junction between the exterior cladding sections. In another embodiment, the hat channel and face plate are made of extruded aluminum, such as 11 gauge 6000 series extruded aluminum.

In another embodiment, an interior corner trim is provided comprising a first wall and a second wall perpendicular to the first wall, forming an L-channel. A first flange is coupled to the first wall, parallel to, and offset from, the first wall. A second flange is coupled to the second wall, parallel to, and offset from, the second wall. The first and second flanges are offset outwardly from the L-channel.

In another embodiment, an exterior corner trim is provided, comprising a first wall and a second wall perpendicular to the first wall to form an L-channel. A first flange is coupled to the first wall, parallel to, and offset from, the first wall. A second flange is coupled to the second wall, parallel to, and offset from, the second wall. The first and second flanges are offset inwardly from the L-channel.

In another embodiment, a Z-channel is provided, comprising a flat central wall having a first flange extending outwards and perpendicular from one edge. A second flange extends outwards perpendicular from the opposite edge. The Z-channel may by positioned beneath and perpendicular to the hat channel, and may also be used to cover edges of the wall.

In another embodiment, a window trim element is provided, comprising an elongated body having a generally rectangular cross section. The body has a wall-facing surface and an opposite exterior-facing surface. The body also has a frame-facing surface perpendicular to the wall-facing and exterior-facing surfaces. The body also has a cladding-facing surface opposite the frame-facing surface. A pair of legs extends from the wall-facing surface to define a channel. A longitudinal cavity is formed in the body. A flange extends outward from the cladding-facing surface of the body, parallel to, and offset from the wall-facing and exterior-facing surfaces.

In another embodiment, the longitudinal cavity has a rectangular portion, and a circular portion on opposite ends of the rectangular portion. A beveled portion connects each circular portion with an end of the rectangular portion. The circular portions are receivable of fasteners to connect perpendicular sections of the window trim elements together.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an isometric, partial-cutaway view of a structural wall embodying the sub-framing system in accordance with the present invention;

FIG. 2 is an isometric view of a hat channel;

FIG. 3 is an isometric view of a face plate;

FIG. 4A is a cross-sectional, plan view of the hat channel and the face plate exemplified as installed in a structural wall;

FIG. 4B is an close-up view of the hat channel and the face plate take along view line B;

FIG. 5 is an isometric view of a Z-channel;

FIG. 6 is a cross-sectional, plan view of the Z-channel exemplified as installed in a structural wall;

FIG. 7 is an isometric view of an inside corner trim;

FIG. 8 is a cross-sectional, plan view of the inside corner trim exemplified as installed in a structural wall;

FIG. 9 is an isometric view of an outside corner trim;

FIG. 10 is a cross-sectional, plan view of the outside corner trim exemplified as installed in a structural wall;

FIG. 11 is an isometric view of a window trim;

FIGS. 12A and 12B are a isometric views of window trims being assembled into a trim-frame assembly; and

FIG. 13 is a cross-sectional, plan view of the trim-frame exemplified as installed in a structural wall.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein. Additionally, as used herein, the term “substantially” is to be construed as a term of approximation.

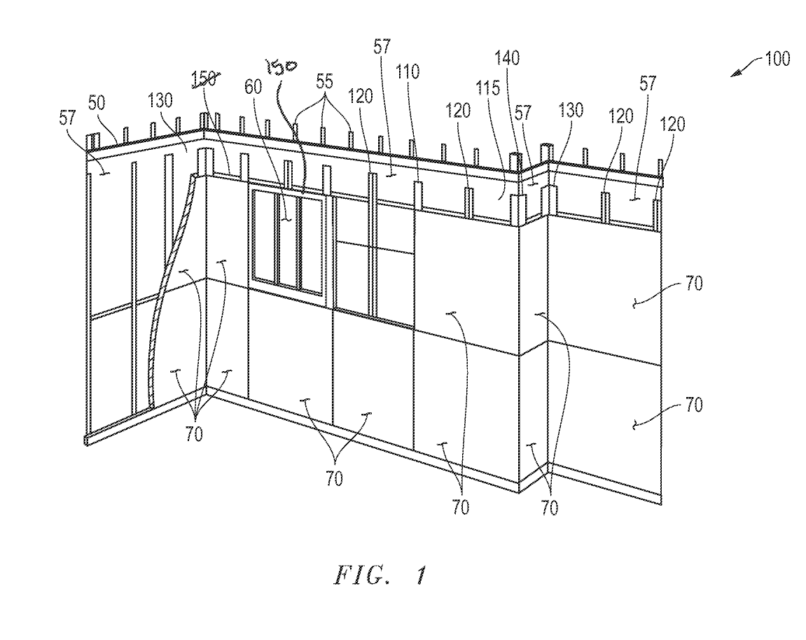

Referring to FIG. 1, sub-framing system 100 is exemplified as installed on a wall 50 of a structure comprising studs 55 (not all shown are labeled) that are covered by sheathing 57 or boarding, sheet rock, etc. Sub-framing system 100 comprises hat channels 110, face plates 115, Z-channels 120, inside corner trims 130, outside corner trims 140, and window trims 150 that assembled into a trim-frame assembly. The parts of framing system 100 are preferably made of 11 gauge 6000 series extruded aluminum. Each hat channel 110 is arranged vertically and secured to wall 50 preferably using self-tapping screws. Face plates 115 (not shown) are snapped into each hat channel 110. Z-channels 120 are also arranged vertically and secured to wall 50 preferably using self-tapping screws. Inside corner trims 130 are arranged vertically and secured to the inside corners of wall 50 preferably using self-tapping screws. Outside corner trim 140 is arranged vertically and similarly secured to the outside corner of wall 50. Window trim 150 is placed around window frame 60. Panels of cladding 70 are then secured to hat channels 110, Z-channels 120, inside corner trims 130, and outside corner trim 140 preferably using rivets. Sub-framing system 100 may be used on the exterior of a building (i.e., as a rain screen) or the interior of a building.

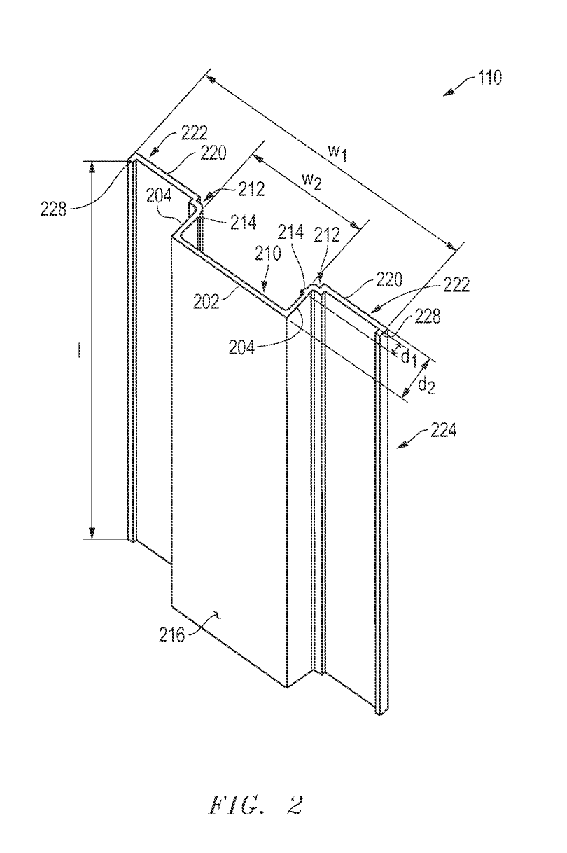

Referring to FIG. 2, an isometric view of hat channel 110 is provided. Hat channel 110 comprises an elongated, planar base 202 and a pair of side walls 204 perpendicularly coupled to the ends of base 202. Base 202 has a width of w₂, which is preferably 2.5 inches. Base 202 has a wall-facing surface 216 for securing hat channel 110 to a wall using a fastener. Side walls 204 are parallel to one another and perpendicular to base 202. A U-shaped channel 210 is defined by the base 202 and side walls 204. Latches 214 are formed on the interior-sides of side walls 204 and protrude into U-shaped channel 210. Latches 214 extend longitudinally the length of U-shaped channel 210 and are offset from the end of the side walls 204 by a depth of d₁, which is preferably 0.227 inches. Cap seats 212 extend above each latch 214 and outward of each side wall 204. Cap seats 212 provide a seat for a face plate 115 (not shown), which secures to latches 214. A pair of flanges 220 is coupled to the cap seats 212 and extends outwards. Flanges 220 have cladding-facing surfaces 222 opposite to the wall-facing surface 216 for securing one or more panels of cladding to hat channel 110. Flanges 220 are offset from the ends of the side walls 204 by cap seats 212. Curls 228 are formed at the distal ends of flanges 220. Hat channel 110 has an overall width of w₁, a depth of d₂, and a length of 1. Preferably, w₁ is 5.438 inches and d₂ is 0.875 inches. Preferably, hat channel 110 is manufactured to have a length 1 of 20 feet and may be cut to a desired size during installation.

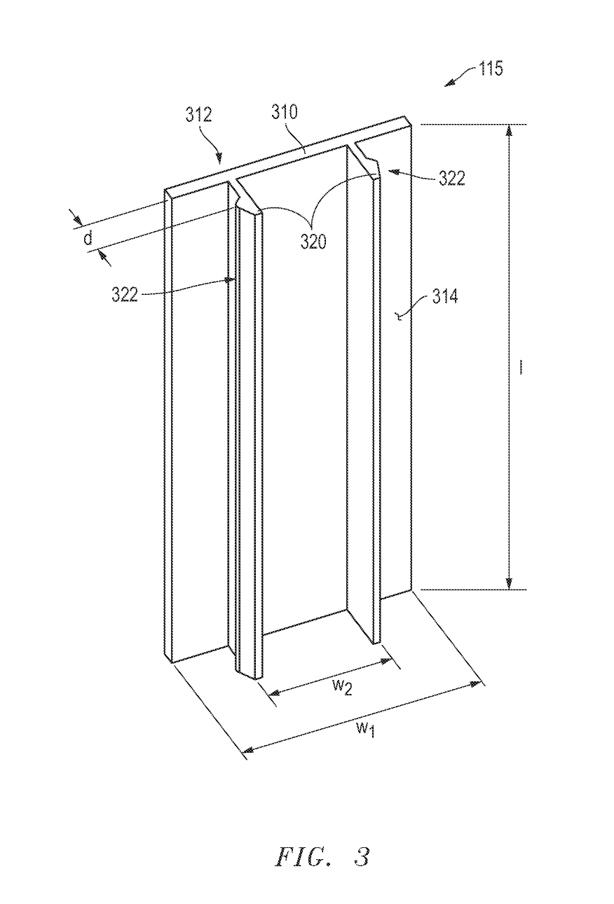

Referring to FIG. 3, an isometric view of face plate 115 is provided. Face plate 115 comprises an elongated, planar body 310 having a rectangular cross section. Body 310 has a width of w₁, which is preferably 2.688 inches. Body 310 has an exterior surface 312 and an opposite, interior surface 314. A pair of parallel, opposing side legs 320 protrudes downward from the interior surface 314 of the body 310 and extends longitudinally along the interior surface 314. Side legs 320 are separated by a channel having a width of w₂, which is preferably 2.267 inches. Strike ridges 322 extend outward of each side leg 320. Strike ridges 322 are offset from the body 310 by a depth of d₁ which is preferably 0.227 inches. Strike ridges 322 engage latches 214 of a hat channel 110 (not shown), which allows face plate 115 to be snapped into hat channel 110.

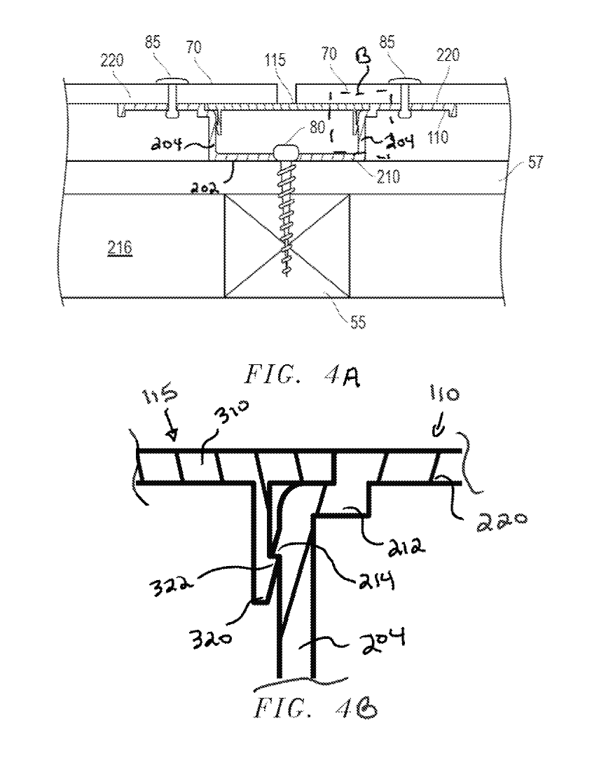

Referring to FIGS. 4A and 4B, hat channel 110 and face plate 115 are exemplified securing panels of cladding 70 to a structural wall 50. Wall 50 comprises stud 55 to which sheathing 57 is secured. Optionally, a water resistant barrier may be applied to the outside surface of the sheet rock (not shown). Hat channel 110 is aligned vertically such that the wall-facing surface 216 (not shown) faces stud 55 and is fastened using a fastener 80 that penetrates base 202, which is preferably a self-tapping screw. Optionally, face plate 115 is “snapped” into hat channel 110, thereby presenting a smooth face for installing paneling and protecting fastener 80 from the external environment. When face plate 115 is snapped in, strike ridges 322 of face plate 115 engage latches 214 of hat channel 110 to secure face plate 115 (more particularly body 310) in compression against cap seats 212. Panels of cladding 70 are then secured to the cladding-facing surfaces 222 (not shown) of flanges 220 preferably using fasteners 85, which are preferably rivets. Hat channel 110 is particularly advantageous for securing joints where two panels of cladding come together. However, hat channel 110 may also secure a single channel (not shown). Alternatively when securing a single panel, hat channel 110 may be reversed, i.e., the cladding-facing surfaces face the wall while wall-facing faces are used to secure cladding (not shown).

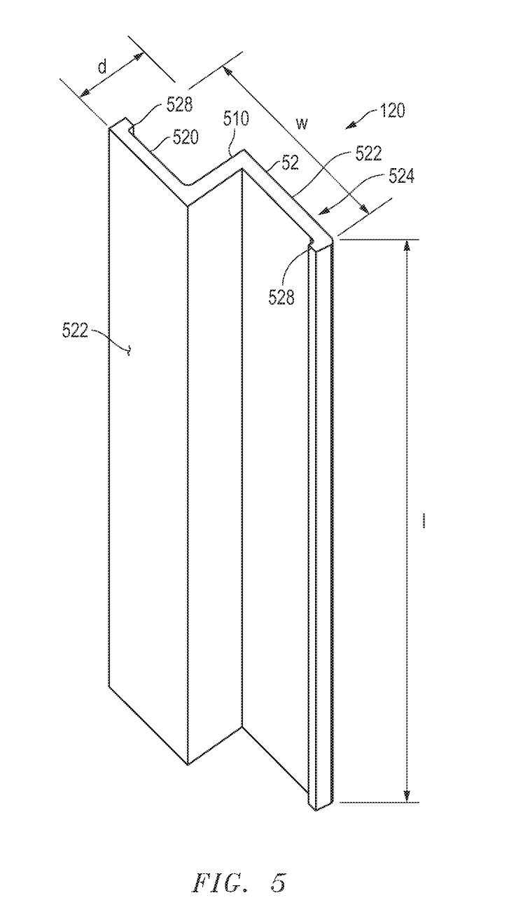

Referring to FIG. 5, an isometric view of Z-channel 120 is provided. Z-channel 120 comprises a central wall 510 having a pair of flanges 520 extending perpendicularly outward from central section 510. The pair of flanges 520 is parallel and offset from one another by a depth of d. Offset d is preferably 0.875 inches. Curls 528 are formed at the ends of each flange 520. Z-channel 120 has a cladding-facing surface 522 to which a panel of cladding may be secured and a wall-facing surface 524 used to secure Z-channel 120 to a structural wall. Z-channel 120 has a width of w, which is preferably 2.875 inches. Z-channel 120 has a length of l. Preferably, Z-channel 120 is manufactured to have a length of 20 feet and may be cut to a desired size during installation.

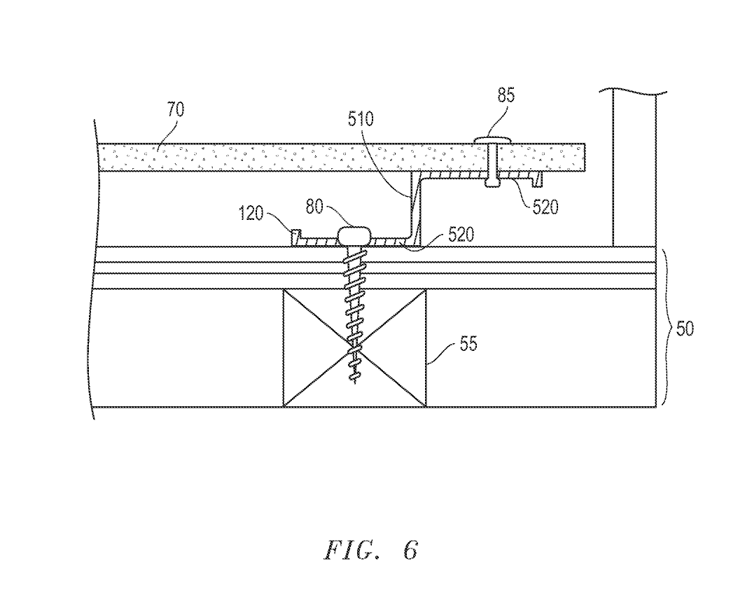

Referring to FIG. 6, Z-channel 120 is exemplified securing a panel of cladding 70 to a structural wall 50. Wall 50 comprises stud 55 to which sheathing 57 is secured. Optionally, a water resistant barrier (not shown) may be applied to the exterior surface of the sheathing 57. Z-channel 120 is aligned vertically such that the wall-facing surface 524 (not shown) faces stud 55 and is then preferably secured using fastener 80, which is preferably a self-tapping screw. A panel of cladding 70 is then secured to the cladding-facing surface 522 (not shown) preferably using fasteners 85, which are preferably rivets. Z-channels are particularly advantageous for securing an end or central portion of a single panel of cladding (see also FIG. 1).

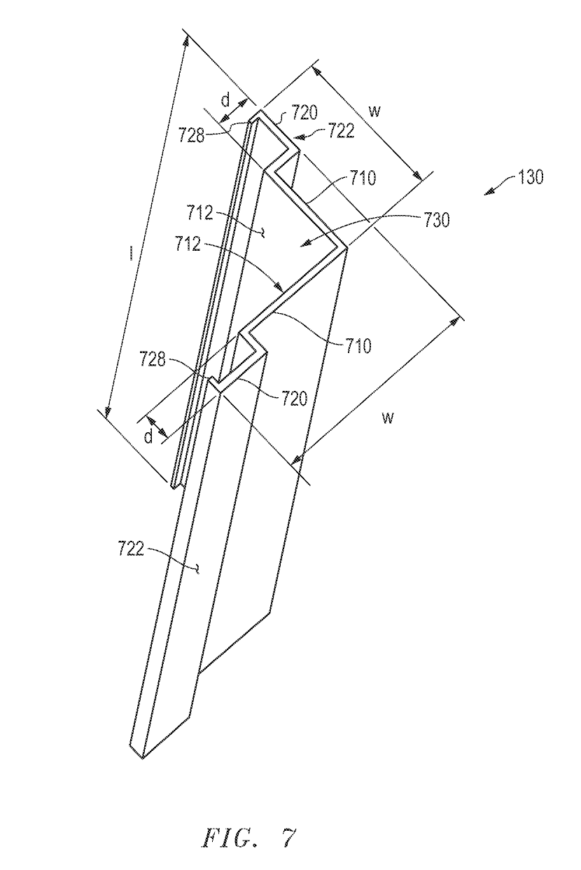

Referring to FIG. 7, an isometric view of inside corner trim 130 is provided. Inside corner trim 130 comprises a pair of elongated walls 710 that are perpendicular to one another and form an L-channel 730. Each wall 710 has a cladding-facing surface 712 to which a panel of cladding may be secured. Flanges 720 are coupled to the ends of walls 710. Each flange 720 is parallel to and offset outwards away from the L-shaped channel 730 by an amount d from its respective wall 710. Offset d is preferably 0.875 inches. Curls 728 are formed at the ends of each flange 720. Each flange 720 has a wall-facing surface 722 for securing inside corner trim 130 to a structural wall. Inside corner trim 130 has a width of w, which is preferably 4.75 inches. Inside corner trim 130 is preferably symmetrical, but need not be. Inside corner trim 130 has a length of l. Preferably, inside corner trim 130 is manufactured to have a length of 20 feet and may be cut to a desired size during installation.

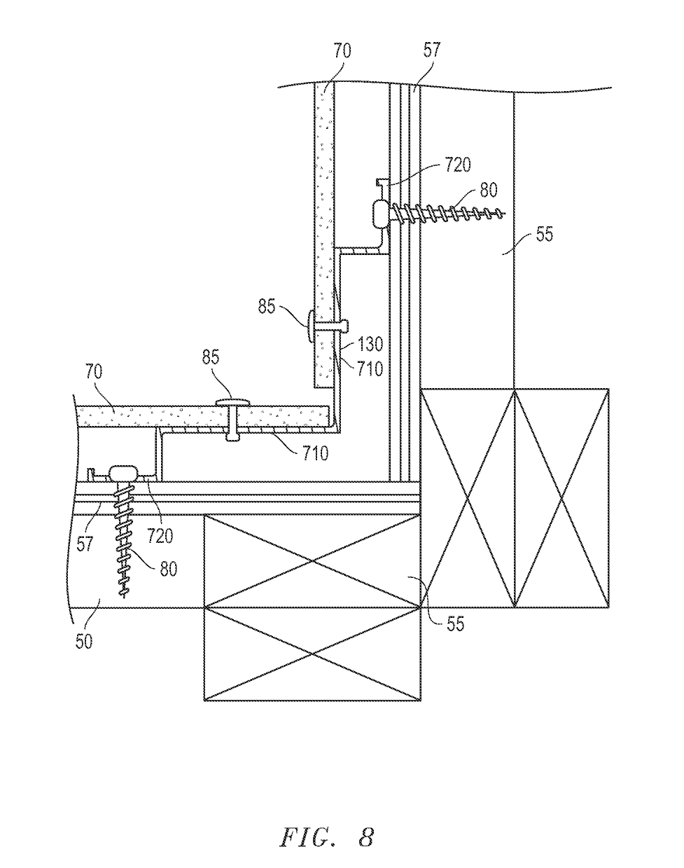

Referring to FIG. 8, inside corner trim 130 is exemplified securing panels of cladding 70 to a structural wall 50 that forms a corner. Wall 50 comprises studs 55 to which sheathing 57 is secured. Optionally, a water resistant barrier (not shown) may be applied to the outside of sheathing 57. Inside corner trim 130 is aligned vertically such that surfaces 722 (not shown) of flanges 720 urge against wall 50 and align with studs 55. Inside corner trim 130 is secured using fasteners 80, which are preferably self-tapping screws. Panels of cladding 70 are then secured to surfaces 712 (not shown) of walls 710 preferably using fasteners 85, which are preferably rivets.

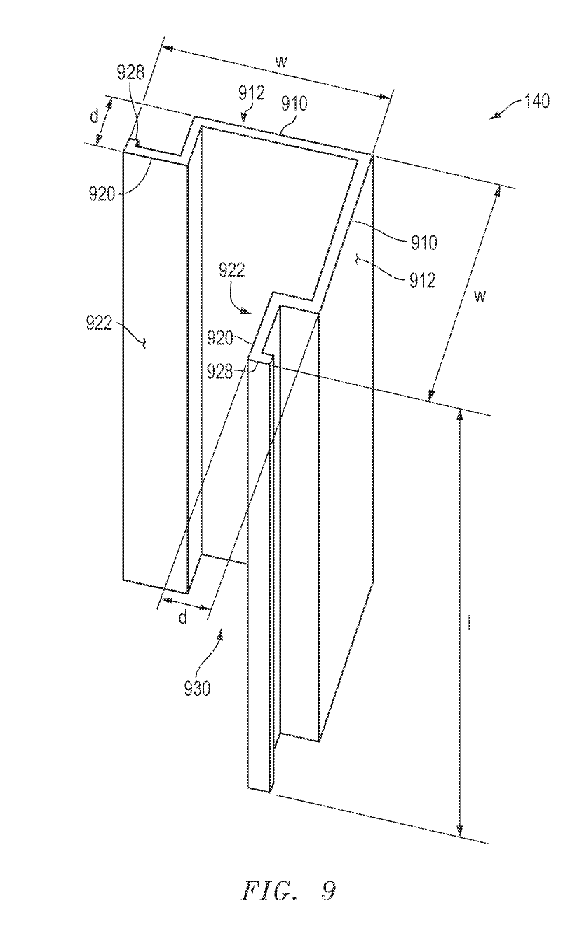

Referring to FIG. 9, an isometric view of outside corner trim 140 is provided. Outside corner trim 140 comprises a pair of elongated walls 910 that are perpendicular to one another and form an L-channel 930. Each wall 910 has a cladding-facing surface 912 to which a panel of cladding may be secured. Flanges 920 are coupled to the ends of wall 910. Each flange 920 is parallel to and offset inwards towards the L-channel 930 by an amount d from its respective wall 910. Offset d is preferably 0.875 inches. Curls 928 are formed at the ends of each flange 920. Each flange 920 has a wall-facing surface 922 for securing outside corner trim 140 to a structural wall. Outside corner trim 140 has a total width of w, which is preferably 4.75 inches. Outside corner trim 140 is preferably symmetrical, but need not be. Outside corner trim 140 has a length of l. Preferably, outside corner trim 140 is manufactured to have a length of 20 feet and may be cut to a desired size during installation.

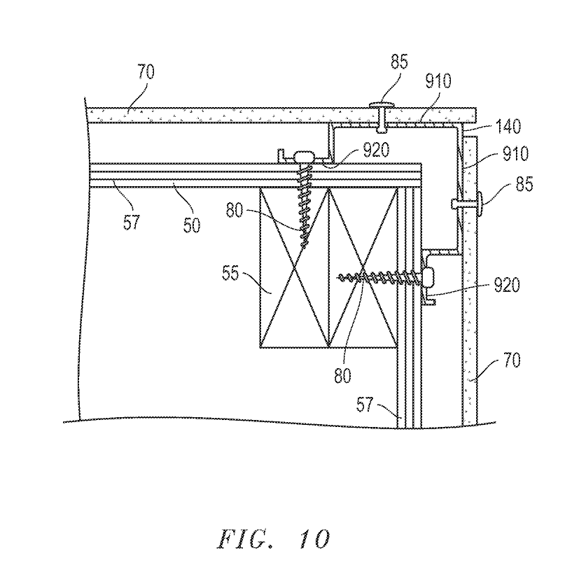

Referring to FIG. 10, outside corner trim 140 is exemplified securing panels of cladding 70 to a structural wall 50 that forms a corner. Wall 50 comprises stud 55 to which sheathing 57 (or sheet rock or boarding) is secured. Optionally, a water resistant barrier (not shown) may be applied to the outside of the sheathing. Outside corner trim 140 is aligned vertically such that wall-facing surfaces 922 (not shown) of flanges 920 urge against wall 50 and align with stud 55. Outside corner trim 140 is secured using fasteners 80, which are preferably self-tapping screws. Panels of cladding 70 are then secured to cladding-facing surfaces 912 (not shown) of walls 910 using fasteners 85, which are preferably rivets.

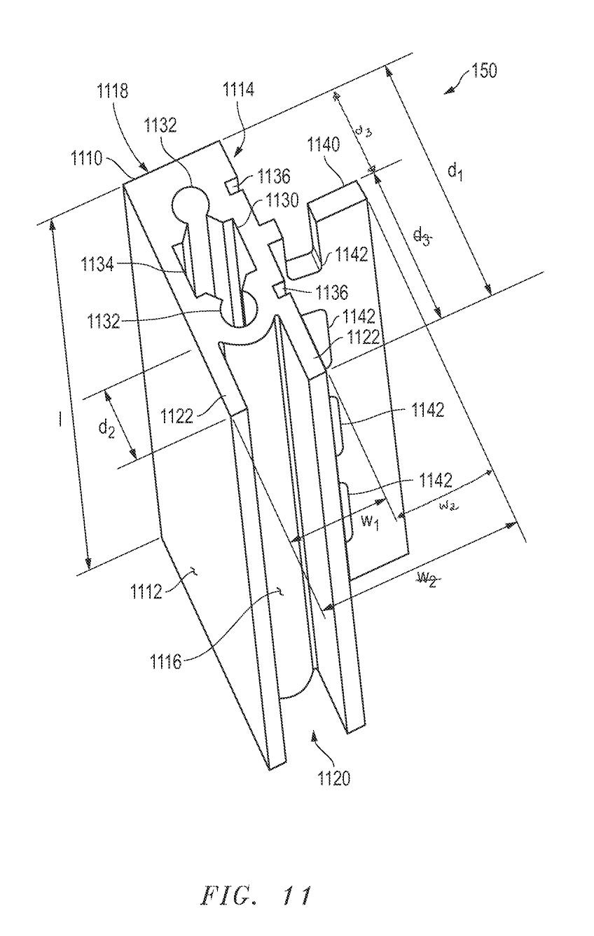

Referring to FIG. 11, an isometric view of window trim 150 is provided. Window trim 150 comprises an elongated body 1110 that generally has a rectangular cross section and has a width of w₁ and a depth of d₁. Preferably, w₁ is 0.5 inches and d₁ is 1.188 inches. Body 1110 has a frame-facing surface 1112 and an opposite cladding-facing surface 1114. Body 1110 also has a wall-facing surface 1116 perpendicular to the frame-facing surface 1112 and the cladding-facing surface 1114. Body also has an exterior-facing surface 1118 opposite the wall-facing surface 1116. A pair of legs 1122 is formed along the wall-facing surface 1116 that define U-channel 1120. The wall-facing surface 1116 between legs 1122 is preferably rounded. U-channel 1120 has a depth of d₂, which is preferably 0.266 inches. The U-channel conserves material and also enables easier trimming to make fine adjustments to the depth of window trim 115.

Central cavity 1130 is formed longitudinally through the length of body 1110 and is parallel to U-channel 1120. Central cavity 1130 comprises a pair of cylindrical, fastener bosses 1132, or more particularly screw bosses. Fastener bosses 1132 provide an opening for fasteners, which are preferably self-tapping screws, which are used to assemble window trims 115 into a trim-frame assembly as explained below. In addition to fastener bosses 1132, central cavity 1130 has a rectangular channel 1134. Channel 1134 reduces weight and the amount of material required. Notches 1136 are formed along an exterior side of body 1110 and run parallel to each fastener boss 1132. Notches 1136 provide a visual aid for identifying the location of fastener bosses 1132 and also reduce material requirements.

Flange 1140 protrudes outward from cladding-facing surface 1114 of body 1110 by an amount of w₂. Preferably, w₂ is 0.5 inches. Flange 1140 is parallel to, and offset from, the exterior-facing surface 1118 by a depth of d₃, which is preferably 0.688 inches. Perforations 1142 are formed along the length of flange 1140, which permit air circulation when installed and also reduce weight and material requirements.

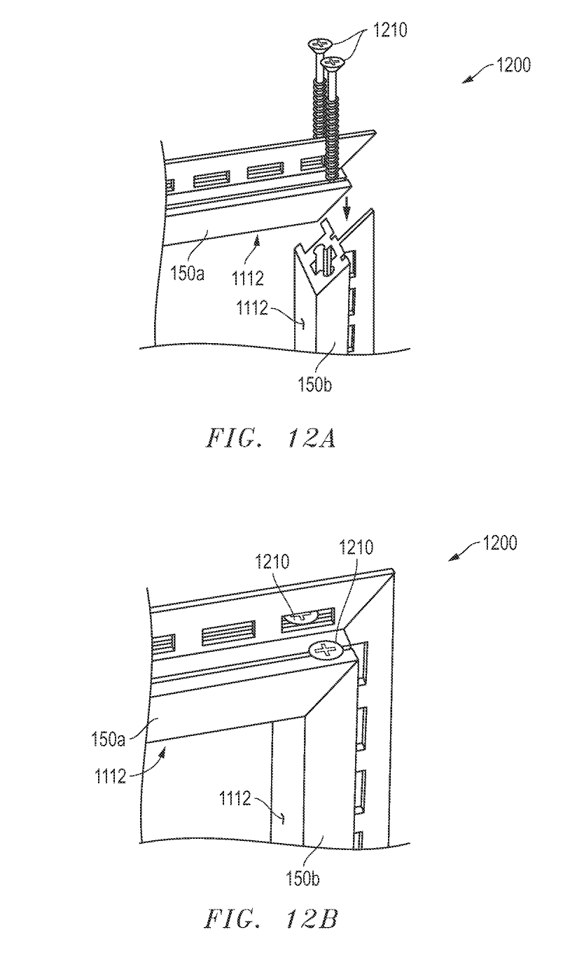

Referring to FIGS. 12A and 12B, a pair of window trims 150a and 150b is exemplified being joined together to create a trim-frame assembly 1200. First, window trims 150a and 150b are cut to the desired length and then the ends of each window trim are cut at a 45 degree angle. The length of frame-facing surface 1112 of each window trim corresponds to the exterior dimensions of a window or object that is being framed. Then, window trims 150a and 150b are brought together and fastened using fasteners 1210, which are preferably self-tapping screws.

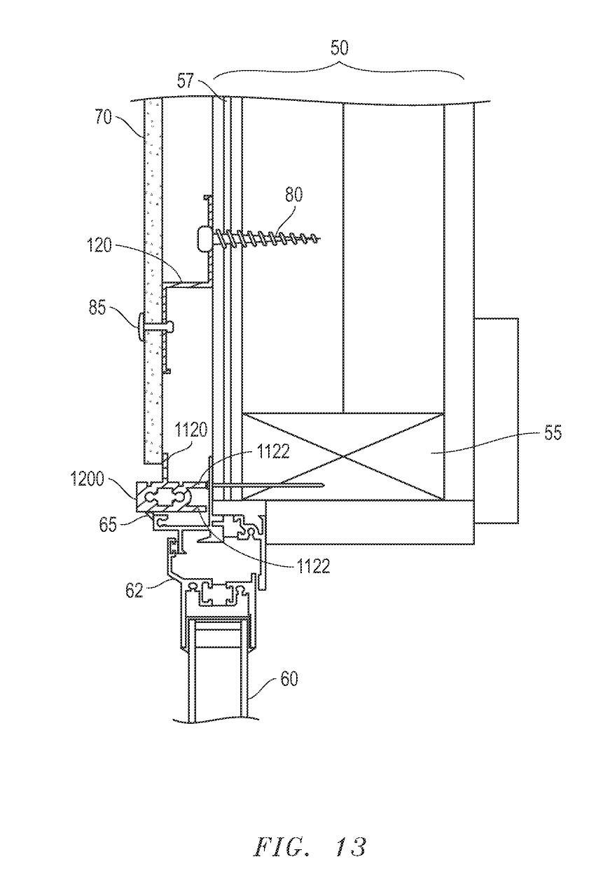

Referring to FIG. 13, trim-frame assembly 1200 is exemplified framing outside window 60, which is a nail-on window as is typically used in residential structures. The window frame 62 of window 60 is nailed to stud 55 of structural wall 50. Window trims 150 (not shown) are assembled into a trim assembly 1200 as described above. Trim-frame assembly 1200 is then positioned around the window frame 62. Preferably, trim-frame assembly 1200 has the same finish as the window frame 62, which is aesthetically desirable and provides an effect that trim-frame assembly is part of window frame 62. Legs 1122 of trim-frame assembly 1200 may be trimmed to adjust the depth of trim assembly 1200. Preferably, the depth of trim-frame assembly 1200 is adjusted such that the exterior surface of trim-frame assembly 1200 is flush with the exterior face of cladding panels 70, which is aesthetically desirable. After adjusting the depth, panels of cladding 70 are installed. The edge of panel 70 urges against flange 1140 of trim-frame assembly 1200 thereby securing trim-frame assembly 1200 to wall 50. No fasteners are required to secure trim-frame assembly 1200 in place. Optionally, trim-frame assembly 1200 may be caulked to window frame 62 using caulk 65.

It is understood that the present invention may take many forms and embodiments. Accordingly, several variations may be made in the foregoing without departing from the spirit or the scope of the invention.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A sub-framing wall system for supporting cladding attached to a wall, the sub-framing system comprising:
a hat channel comprising:
an elongated planar base;
a pair of side walls extending upward from the base;
a latch extending inward from each side wall;
a cap seat extending above each latch and outward of each side wall; and,
a first and second flange extending outward of each cap seat;
a face plate securable to the hat channel, comprising:
an elongated, planar body having an interior and opposite exterior surface;
a pair of opposing side legs extending downward from the interior surface of the body; and,
a strike ridge extending outward from each side leg.

2. The sub-framing wall system of claim 1, further comprising:
the hat channel attached to a wall surface by fasteners that penetrate the base; and,
wherein the fasteners attached to the base are protected from the external environment by the face plate.

3. The sub-framing wall system of claim 1, further comprising:
the hat channel attached to a wall surface by fasteners that penetrate the base; and,
the strike ridge of the face plate engaging the latches of the hat channel to secure the face plate in compression against the cap seat of the hat channel; and,
wherein the fasteners attached to the base are protected from the external environment by the face plate.

4. The sub-framing wall system of claim 1, wherein the hat channel and face plate are made of extruded aluminum.

5. The sub-framing wall system of claim 1, wherein the hat channel and face plate are made from 11 gauge 6000 series extruded aluminum.

6. The sub-framing wall system of claim 1, further comprising:
the hat channel secured to a wall panel by fasteners that extend through the base;
the strike ridge of the face plate engaging the latches of the hat channel to secure the face plate in compression against the cap seat of the hat channel;
a first panel of cladding secured to the first flange;
a second panel of cladding secured to the second flange; and,
the first panel adjacent to the second panel at a position over the face plate to provide a solid backing at the adjacency of the first and second panels.

7. The sub-framing wall system of claim 1, further comprising:
an inside corner trim comprising:
a first wall;
a second wall perpendicular to the first wall to form an L-channel;
a first flange coupled to the first wall, the first flange parallel to, and offset from, the first wall;
a second flange coupled to the second wall, the second flange parallel to, and offset from, the second wall; and,
the first and second flanges being offset outwardly from the L-channel.

8. The sub-framing wall system of claim 1, further comprising:
an exterior corner trim comprising:
a first wall;
a second wall perpendicular to the first wall to form an L-channel;
a first flange coupled to the first wall, the first flange parallel to, and offset from, the first wall;
a second flange coupled to the second wall, the second flange parallel to, and offset from, the second wall; and,
the first and second flanges being offset inwardly from the L-channel.

9. The sub-framing wall system of claim 1, further comprising:
a Z-channel, comprising:
a central wall;
a first flange extending perpendicularly outward from one edge of the central wall;
and,
a second flange extending perpendicularly outward from the opposite edge of the central wall, in a direction opposite to that of the first flange.

10. The sub-framing wall system of claim 1 further comprising:
a window trim comprising:
an elongated body having a generally rectangular cross section;
a wall-facing surface and an opposite exterior-facing surface;
a frame-facing surface perpendicular to the wall-facing and exterior-facing surfaces;
a cladding-facing surface opposite the frame-facing surface;
a pair of legs extending from the wall-facing surface to define a channel;
a longitudinal cavity formed in the body; and,
a flange extending outward from the cladding-facing surface of the body, parallel to, and offset from the wall-facing and exterior-facing surfaces.

11. The window trim of claim 10, further comprising:
the longitudinal cavity having at least one fastener boss.

12. The window trim of claim 10, further comprising:
the longitudinal cavity having at least two fastener bosses.

13. The window trim of claim 10, the longitudinal cavity, further comprising:
a rectangular portion;
a circular portion on opposite ends of the rectangular portion; and, a beveled portion connecting each circular portion with an end of the rectangular portion; and,
the circular portions receivable of a fastener.

14. The window trim of claim 100 further comprising:
perforations formed in the flange.

15. The window trim of claim 10, further comprising:
four lengths of the window trim are assembled in perpendicular relationship to form a trim-frame assembly over a window frame.

16. The sub-framing wall system of claim 1, further comprising:
a curl formed on an end of the flanges of the hat channel.

17. A sub-framing wall system for supporting cladding attached to a wall, the sub-framing system comprising:
a hat channel comprising:
an elongated planar base;
a pair of side walls extending upward from the base;
a latch extending inward from each side wall;
a cap seat extending above each latch and outward of each side wall; and,
a first and second flange extending outward of each cap seat;
the hat channel secured to a wall panel by fasteners extended through the base;
a face plate, comprising:
an elongated, planar body having an interior and an opposite exterior surface;
a pair of opposing side legs extending downward from the interior surface of the body; and,
a strike ridge extending outward from each side leg;
the strike ridges engaging the latches of the hat channel to secure the face plate in compression against the cap seat of the hat channel;
a first panel of cladding secured to the first flange;
a second panel of cladding secured to the second flange; and,
the first panel adjacent to the second panel at a position over the face plate.
